(19) United States
(12) Patent Application Publication
(10) Pub. No.: US 2017/0209002 A1
(43) Pub. Date: Jul. 27, 2017

(54) COLANDER SHAFTED KITCHEN UTENSIL

(71) Applicant: Michael A. Scarpati, Philadelphia, PA (US)

(72) Inventor: Michael A. Scarpati, Philadelphia, PA (US)

(21) Appl. No.: 15/409,452

(22) Filed: Jan. 18, 2017

Related U.S. Application Data
(60) Provisional application No. 62/286,172, filed on Jan. 22, 2016.

(51) Int. Cl. A47J 43/22; A47J 43/28; A47J 43/24

(52) U.S. Cl. CPC A47J 43/22; A47J 43/24; A47J 43/281

(57) ABSTRACT

A kitchen or cooking utensil has a head portion and a handle portion. A handle shaft connects the head portion and the handle portion of the utensil. The handle shaft is provided with perforations for straining liquid from foodstuffs that are located in a container. The utensil may optionally incorporate a magnet in the handle shaft near the head portion of the utensil to assist in holding the handle shaft against the rim of the container. In an alternative embodiment, the handle shaft has a grater and/or zester function.

### CROSS REFERENCE TO RELATED APPLICATIONS

This application claims the benefit of U.S. Provisional Application No. 62/286,172, filed Jan. 22, 2016, which is incorporated by reference herein in its entirety.

### BACKGROUND OF THE INVENTION

1. Field of the Invention The present invention relates to a cooking utensil that provides for convenient draining of liquids from a cooking pot or other container while reducing the possibility that some of the foodstuffs contained in the pot or container will fall out of the pot or container and into the sink or drain, which would result in some of the foodstuffs being wasted.

2. Description of the Prior Art Often times during cooking or food preparation activity, it is necessary to drain liquids from a container that contains foods stuffs, which the cook or food preparer desires to keep in the container. For example, when cooking pasta, the pasta is boiled in water, which must be removed from the pasta before the pasta can be served. As other examples, olives, pickles, or tuna are packed in containers along with a quantity of liquid, which must be removed from the container before the olives, pickles, or tuna can be used in a recipe. A colander is a bowl-shaped kitchen utensil with holes, which is primary used for draining excess liquid from food such as pasta. After pasta is boiled in a pot, the pot's contents are emptied into the colander to drain the water from the cooked pasta. Using a colander for draining water from pasta requires pouring the entire contents of the pot, both the pasta and the water, into the colander, which is placed in a sink. Often, the pasta will pass through the colander in whole or in part and contact the bottom surface of the sink resulting in the contamination of the pasta. It would be desirable to have a means to eliminate excess water from the pasta without having to remove the pasta from the pot.

When draining excess liquid from other foods, such as pickles, olives, tuna, and the like, a fork is usually used to keep the foodstuff from falling out of the container as the excess liquid is being drained. Experience has shown that a fork is often inadequate such that some of the foodstuff will fall out and be wasted as the excess liquid is being drained.

Many devices or utensils for draining of excess liquid from foodstuff have been proposed in the prior art, but none are seen to exhibit the unique features of the present invention.

U.S. Pat. No. 2,923,059, issued to Louis Campagna on Feb. 2, 1960,shows a draining spoon having perforations in the head portion of the spoon. The spoon handle shaft has no perforations.

U.S. Pat. No. 8,381,640 B1 issued to Mary Margaret Wilson on Feb. 26, 2013, shows a perforated bowl resembling a colander that is used for noodle making by urging the noodle dough through the perforations in the bowl.

U.S. Pat. No. 8,898,912 B2, issued to Adam Leffler on Dec. 2, 2014, shows a spoon with an indentation or groove in the handle shaft, but there are no perforations in the spoon handle shaft.

U.S. Pat. No. 8,672,249 B2, issued to Eitam Scharf et al. on Mar. 18, 2014, shows an herb grinder having a perforated and grooved plate. There is no handle shaft with perforations.

U.S. Pat. No. 8,882,010 B2, issued to Eitam Scharf et al. on Nov. 11, 2014, shows an herb grinder having a perforated and grooved plate. There is no handle shaft with perforations.

U.S. Pat. No. D325,327, issued to Raymond C. Y. Tam et al. on Apr. 14, 1992, shows a strainer ladle with perforations in the head portion of the ladle. The ladle handle shaft has no perforations.

U.S. Pat. No. D468,596 S, issued to Lela M. Bluemond on Jan. 14, 2003, shows a spoon strainer having perforations in the head portion of the spoon. The spoon handle shaft has no perforations.

U.S. Pat. No. D557,085 S, issued to Ellis N. Shamoon on Dec. 11, 2007, shows a cutting board with a strainer portion that is provided with perforations. There is no handle shaft with perforations.

U.S. Pat. No. D558,541 S, issued to Ellis N. Shamoon on Jan. 1, 2008, shows a cutting board with a collapsible strainer portion that is provided with perforations. There is no handle shaft with perforations.

U.S. Pat. No. D627,610 S, issued to Stuart Harvey Lee et al. on Nov. 23, 2010, shows a strainer ladle with perforations in the head portion of the ladle. The ladle handle shaft has no perforations.

U.S. Pat. No. D649,415 S, issued to Wilfredo Williams on Nov. 29, 2011, shows a ladle with a strainer lid, which is provided with perforations. The ladle handle shaft does not have a plurality of perforations for straining liquid from foodstuffs.

United States patent application publication no. 2003/0217649 A1, by Luca Leonori and published on Nov. 27, 2003, shows a colander with a perforated bowl and supporting legs. There is no handle shaft with perforations.

U.S. Pat. No. D540,973 S, issued to Sergio Maestoso on Apr. 17, 2007, shows a light fixture made up of a strainer spoon and a colander. The spoon handle shaft has no perforations.

U.S. Pat. No. 2,875,515, issued to Frank R. Sieminski on Mar. 3, 1959,shows a spoon having a holder for decorative panels provided in the spoon handle shaft. The spoon handle shaft has no perforations.

U.S. Pat. No. D734,104 S, issued to Stuart Harvey Lee et al. on Jul. 14, 2015,shows a colander scoop having perforations in the head portion of the scoop. The scoop handle shaft has no perforations.

The need persists in the art for a device that will allow convenient draining of excess liquid from a container while preventing foodstuff in the container from falling out or coming into contact with potentially contaminated surfaces.

### SUMMARY OF THE INVENTION

The present invention is directed to a kitchen or cooking utensil having a head portion and a handle portion. A handle shaft connects the head portion and the handle portion of the utensil. The handle shaft is provided with perforations for straining liquid from foodstuffs that are located in a container. The utensil may optionally incorporate a magnet in the handle shaft near the head portion of the utensil to assist in holding the handle shaft against the rim of the container. The head portion of the utensil can be the head portion of a spoon, fork, ladle, spatula, scoop, spaghetti ladle, or the like, or the perforated or strainer versions of any of these. The handle shaft can be in the form of an elongated flat bar or plate that is provided with a plurality of perforations distributed over at least a portion of the area of the handle shaft in plan view.

The colander shafted kitchen utensil removes the need for a colander when cooking pasta because it allows the pasta to be drained directly from the pot. The shaft of the utensil is placed over one side of the top opening of the pot and in part magnetically held to the rim of the pot. This will help hold the utensil in place when the cook drains the pot. With one hand the cook holds the handle of the colander shafted kitchen utensil and in the other hand holds the handle of the pot. To drain the liquid from the pot, the cook tilts the pot over the sink and the shaft allows liquid to pass through while retaining the solids inside the pot.

Any cook looking to minimize cleanup time and effort while cooking pasta would benefit from the present invention. By using the colander shafted kitchen utensil, the cook eliminates the need for a standard colander and the additional effort required to clean the colander. This also reduces the number of steps necessary to cook and drain pasta with a standard colander. The present invention makes the cooking experience more simple and time efficient. In an alternative embodiment, the handle shaft of the present invention can be configured as a coarse grater or a fine grater or zester.

It is an aspect of the present invention to provide a utensil for use in food preparation, the utensil comprising:

a head portion having a first food processing capability;

a handle portion for grasping by a user to hold and manipulate the utensil; and

a handle shaft connecting the handle portion to the head portion, the handle shaft having a front surface, and a rear surface, the handle shaft having a second food processing capability,

wherein the handle shaft has one or more perforations that extend completely through the handle shaft from the front surface to the rear surface and that are dimensioned and configured to serve for the second food processing capability.

Food processing capability or function as used herein can be one or more of, but not limited to, chopping, cutting, grinding, grating, zesting, food handling including manipulating, moving, conveying, flipping, mixing, stirring, or serving, straining, and draining.

It is an aspect of the present invention to provide a utensil for use in food preparation, the utensil being useful for straining liquid from foodstuff in a container, wherein the container has an opening defined by a rim, the utensil comprising:

a head portion;

a handle portion for grasping by a user to hold and manipulate the utensil; and

a handle shaft connecting the handle portion to the head portion,

wherein the handle shaft is adapted to be placed against the rim of the container to thereby create a barrier covering at least a portion of the opening of the container and wherein the handle shaft has one or more perforations that extend completely through the handle shaft and that are dimensioned and configured to allow liquid in the container to flow through the handle shaft while the foodstuff is at least substantially prevented from passing through the handle shaft.

It is another aspect of the present invention to provide a utensil, incorporating the aspect of the invention described above, further comprising a magnet embedded in said handle shaft near said head portion to aid in holding said handle shaft against the rim of the container.

It is yet another aspect of the present invention to provide a utensil, incorporating any of the aspects of the invention described above, wherein the handle shaft defines an area in plan view and wherein the plurality of perforations are distributed over at least a portion of the area of the handle shaft in plan view.

It is yet another aspect of the present invention to provide a utensil, incorporating any of the aspects of the invention described above, wherein the handle shaft is in the form of an elongated flat plate.

It is yet another aspect of the present invention to provide a utensil, incorporating any of the aspects of the invention described above, wherein the handle shaft is in the form of a rectangular, elongated flat plate.

It is yet another aspect of the present invention to provide a utensil, incorporating any of the aspects of the invention described above, wherein the head portion is a ladle head portion.

It is yet another aspect of the present invention to provide a utensil, incorporating any of the aspects of the invention described above, wherein the head portion is a spoon head portion.

It is yet another aspect of the present invention to provide a utensil, incorporating any of the aspects of the invention described above, wherein the head portion has a plurality of perforations to provide a straining capability.

It is yet another aspect of the present invention to provide a utensil, incorporating any of the aspects of the invention described above, wherein the handle portion has a distal end that is farthest from the handle shaft and wherein the distal end of the handle portion is provided with a hole for hanging the utensil on a hook or peg for storage.

It is yet another aspect of the present invention to provide a utensil, incorporating any of the aspects of the invention described above, wherein the handle shaft has a plurality of perforations to provide a straining capability.

It is yet another aspect of the present invention to provide a cooking utensil including an ergonomic handle; a wide shaft wherein the shaft is slotted with one or more holes or perforations; a small magnet attached to the neck of the utensil; and wherein the utensil neck is attached to a spoon head.

It is yet another aspect of the present invention to provide a utensil, incorporating any of the aspects of the invention described above, wherein the handle, shaft and head of the utensil are all molded in one solid piece and the magnet is placed in the mold such that the magnet becomes embedded into the utensil handle shaft.

It is yet another aspect of the present invention to provide a utensil, incorporating any of the aspects of the invention described above, wherein the handle is equipped with a small hole, which is located at the end of the handle that is farthest from the utensil head portion, for hanging/storing the utensil on a hook or peg.

These and other aspects of the present invention will be made clearer upon study of the detailed description of the invention and the claims provided below and the appended drawings.

### BRIEF DESCRIPTION OF THE DRAWINGS

FIG. 1 is a front perspective view of the utensil according to the present invention.

FIG. 2 is a rear perspective view of the utensil according to the present invention.

FIG. 3 is a front plan view of the utensil according to the present invention.

FIG. 4 is a rear plan view of the utensil according to the present invention.

FIG. 5 is an environmental view of the utensil according to the present invention showing the handle shaft of the utensil positioned against the rim of a container.

FIG. 6 is an environmental view of the utensil according to the present invention showing the handle shaft of the utensil positioned against the rim of a container while liquid is being drained from the container or pot into a kitchen sink.

FIG. 7 is a front perspective view of a second embodiment of the utensil according to the present invention.

The same reference characters denote the corresponding features consistently throughout the attached drawings.

### DETAILED DESCRIPTION OF THE PREFERRED EMBODIMENTS

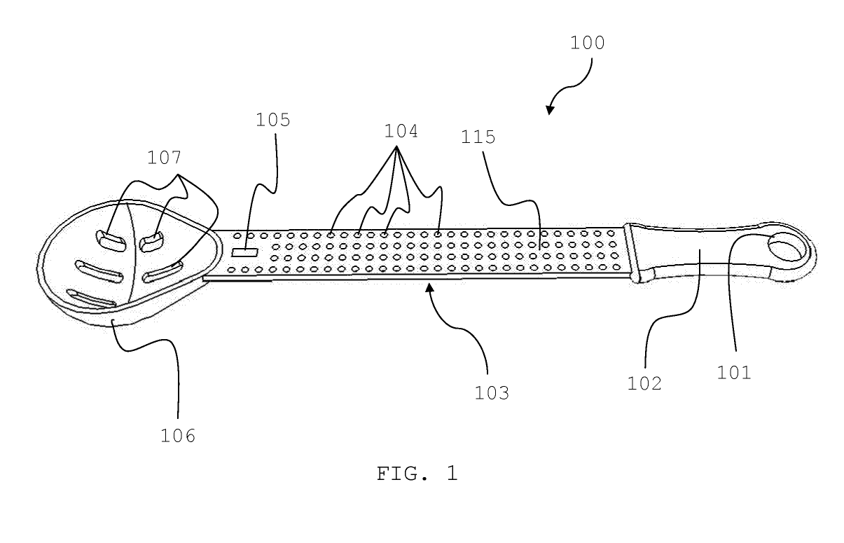

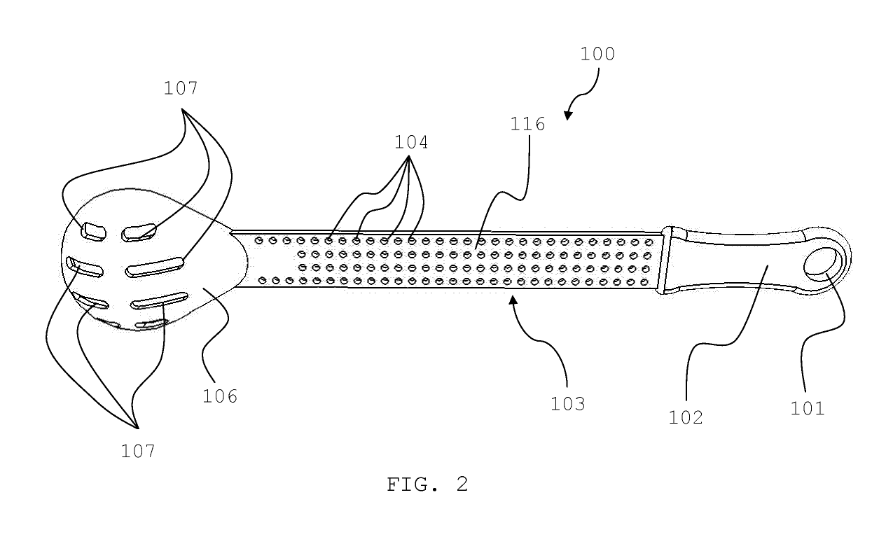

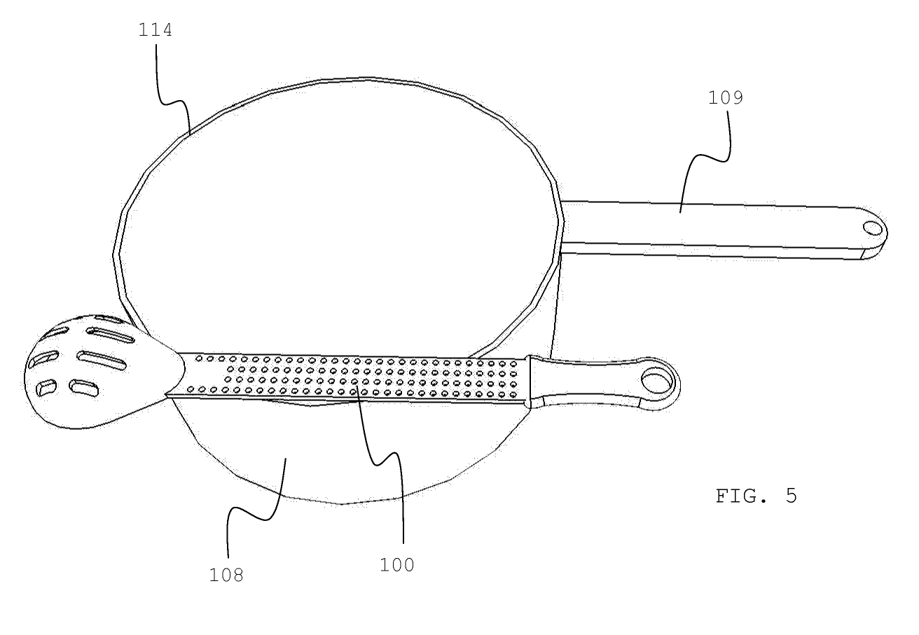

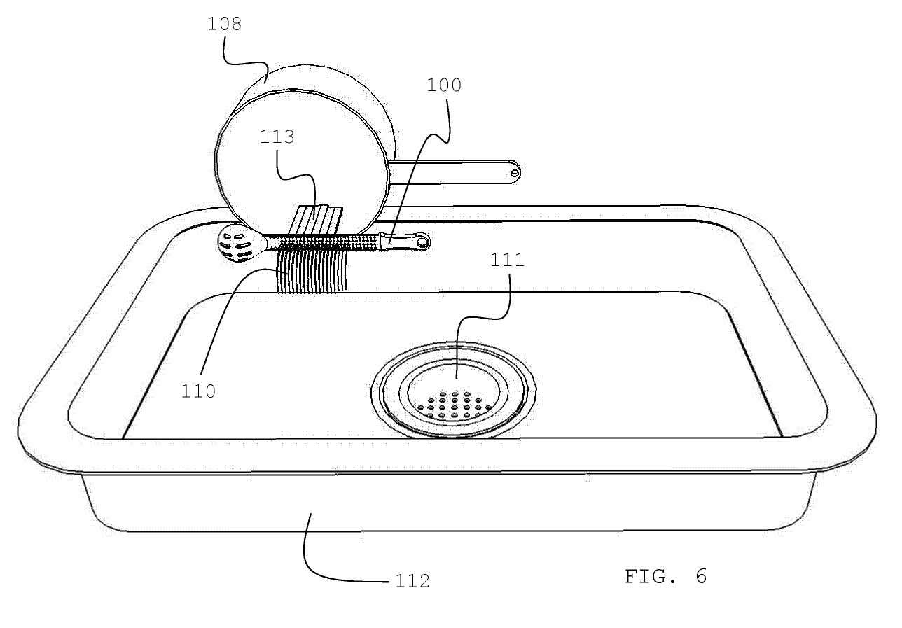

Referring to FIGS. 1-6, an embodiment 100 of a utensil according to the present invention can be seen. The utensil 100 is for use in food preparation. The utensil 100 is useful for straining liquid 110 from foodstuff, for example pasta 113, in a container 108. In the illustrated example, the container 108 is a pot. The container 108 has an opening defined by a rim 114.

The utensil 100 includes a head portion 106, a handle portion 102 for grasping by a user to hold and manipulate the utensil 100, and a handle shaft 103 connecting the handle portion 102 to the head portion 106. The head portion 106 may replicate the head portion of any useful food preparation utensil. For example, the head portion 106 may replicate the head portion of a spoon, fork, ladle, spatula, scoop, spaghetti ladle, or the like, or the perforated or strainer versions of any of these. In the illustrated embodiment, the head portion 106 is the head portion of a slotted or perforated spoon or ladle.

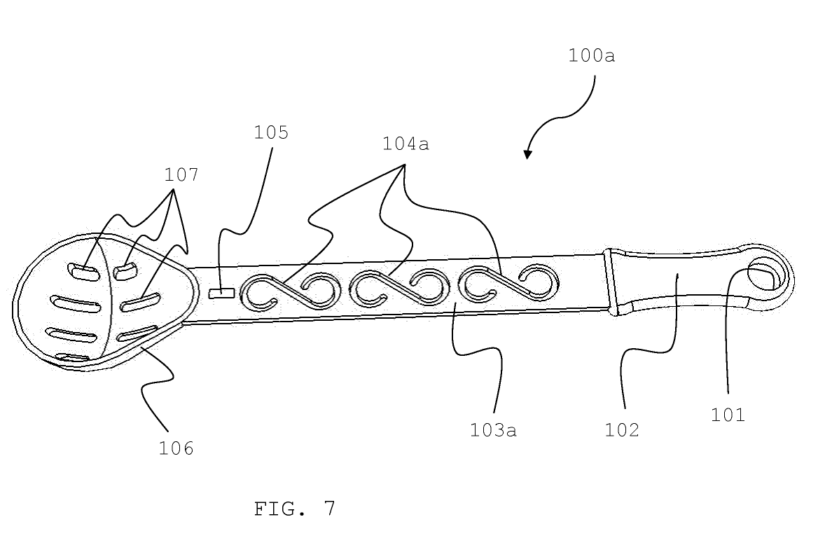

The handle shaft 103 has a front surface 115 and a rear surface 116. The handle shaft 103 is adapted to be placed against the rim 114 of the container or pot 108 to thereby create a barrier covering at least a portion of the opening of the container 108. The handle shaft 103 has a plurality of perforations or holes 104 that extend completely through the handle shaft from the front surface 115 to the rear surface 116. The perforations 104 are dimensioned and configured to allow liquid 110 in the container 108 to flow through the handle shaft 103 while the foodstuff 113 is at least substantially prevented from passing through the handle shaft 103. Preferably, the perforations 104 are dimensioned and configured to allow liquid 110 in the container 108 to flow through the handle shaft 103 while the foodstuff 113 is practically prevented from passing through the handle shaft 103. The perforations 104 can be regular or irregular, may be in any desired shape, and may be distributed over the area of the handle shaft 103 in any desired pattern. As yet another alternative, the perforations 104 may be replaced by one or more labyrinthine or serpentine perforations 104a of the utensil 100a illustrated in FIG. 7. In the illustrated embodiment of FIGS. 1-6, the perforations 104 are circular.

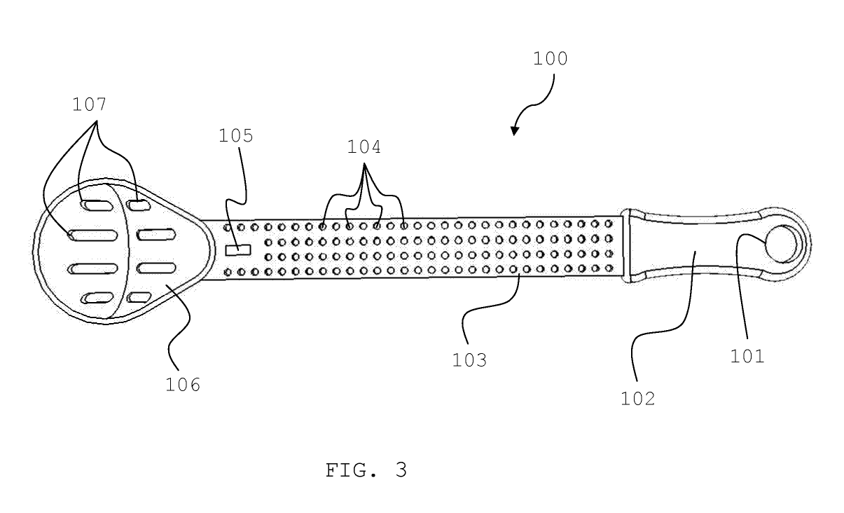

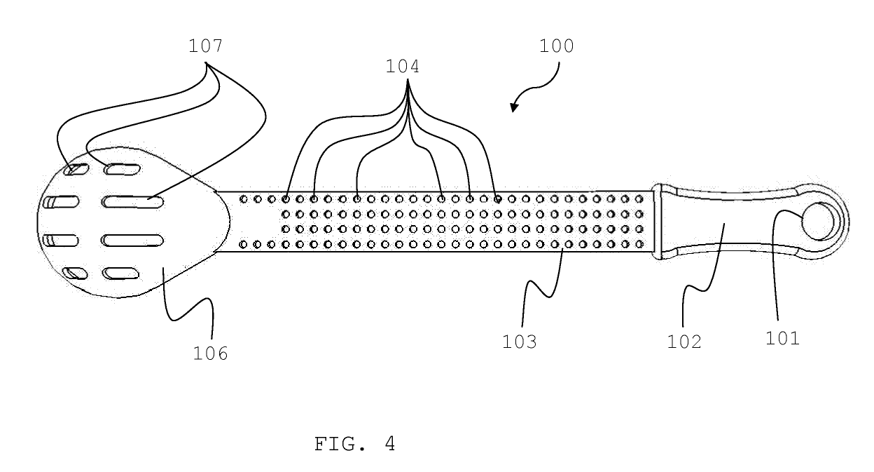

The utensil 100 may optionally include a magnet 105 that is embedded in the handle shaft 103 near the head portion 106 to aid in holding the handle shaft 103 against the rim 114 of the container 108. The handle shaft 103 defines an area in plan view and the plurality of perforations are distributed over at least a portion of the area of the handle shaft 103 in plan view as illustrated in FIGS. 3 and 4.

In the illustrated embodiment, the handle shaft 103 is in the form of an elongated flat plate, and the handle shaft is rectangular. Other suitable handle shaft shapes may also be employed so long as they provide coverage of an adequate portion of the opening of the container 108. Since containers, such as container 108 may come in various sizes, the size and shape of the handle shaft can vary considerably while the utensil 100 would remain of practical value.

In the illustrated embodiment, the head portion 106 is a ladle head portion, which essentially is a large and deep spoon. Another desirable head portion would be the head portion of a large serving spoon. Preferably, the head portion 106 has one or more perforations 107 to provide a straining capability. The handle 102 is equipped with a hole 101, which is located at the end of the handle that is farthest from the utensil head portion 106, for hanging/storing the utensil 100, 100a on a hook or peg.

The utensil 100 or 100a may be coated with a non-stick coating such as TEFLON™. The utensil 100 or 100a may be molded in a single mold such that the handle portion, the head portion, and handle shaft 103 are in one piece. The magnet can be added after the molding operation, or the magnet can be placed in the mold in an insert molding process. The utensil according to the present invention can be made from plastic or polymeric materials, composites, and metals such as copper and copper alloys, aluminum, silver, iron and steel. Stainless steel would be the preferred metal for fabricating the head portion and the handle shaft. When the head portion and the handle shaft are made of stainless steel or other metals, a plastic or rubber grip or handle and the optional magnet can be attached to the head portion and handle shaft assembly after the head portion and handle shaft assembly is fabricated.

The colander shafted kitchen utensil 100 or 100a is a cooking tool designed to help a cook drain the liquid from a pot without the need of an additional draining tool such as a colander. The colander shaft technology improves upon a standard cooking utensil such as a pasta spoon by adding an additional function to the tool. The utensil 100 or 100a is built with an inch wide shaft 103, 103a, which is equipped with holes for drainage. With one hand the cook holds the handle 102 of the colander shafted kitchen utensil and in the other hand holds the handle 109 of the pot 108. Once the spoon shaft 103, 103a is positioned across the rim of the pot 108 so as to cover a portion of the top opening of the pot, the pot 108 can be drained by tilting the pot to the point where its non-liquid contents are up against the shaft and any excess liquid can pass through the shaft's drainage holes 104 or 104a. A small magnet 105 is provided on the shaft of the utensil near the spoon head 106 to help secure the shaft 103 to the rim of the pot 108 when the shaft 103, 103a of the utensil is being used as a draining tool. This keeps the shaft 103, 103a of the utensil secure so it can act as a barrier for the foodstuff within the pot 108 while still allowing liquid to flow through the utensil shaft 103.

It is to be understood that the present invention is not limited to the embodiments described above, but encompasses any and all embodiments within the scope of the appended claims. In addition, the present invention encompasses any and all combinations of the various disclosed aspects of the present invention.

### LISTING OF REFERENCE NUMERALS AND CORRESPONDING PARTS

100, 100a The colander shafted kitchen utensil

101 Hanging hole

102 Utensil handle/handle portion

103, 103a Utensil shaft/handle shaft

104, 104a Utensil shaft perforations

105 Magnet

106 Head portion/spoon head

107 Spoon/head portion slots or perforations

108 Container/Pot

109 Pot handle

110 Liquid from pot

111 Sink drain

112 Sink

113 Pasta/foodstuff

114 Rim of pot/container

115 Front surface of handle shaft 103

116 Rear surface of handle shaft 103

1. A utensil for use in food preparation, the utensil comprising:
a head portion having a first food processing capability;
a handle portion for grasping by a user to hold and manipulate the utensil; and
a handle shaft connecting said handle portion to said head portion, said handle shaft having a front surface, and a rear surface, said handle shaft having a second food processing capability,
wherein said handle shaft has one or more perforations that extend completely through said handle shaft from said front surface to said rear surface and that are dimensioned and configured to serve for said second food processing capability.

2. A utensil according to claim 1, wherein said one or more perforations provided in said handle shaft are a plurality of perforations.

3. A utensil according to claim 1, wherein the utensil is useful for straining liquid from foodstuff in a container, wherein said second food processing capability is a straining capability, wherein the container has an opening defined by a rim,
wherein said handle shaft having a front surface, a rear surface,
wherein said handle shaft is adapted to be placed against the rim of the container to thereby create a barrier covering at least a portion of the opening of the container, and wherein said one or more perforations are dimensioned and configured to allow liquid in the container to flow through said handle shaft while the foodstuff is at least substantially prevented from passing through said handle shaft.

4. A utensil according to claim 3, further comprising a magnet embedded in said handle shaft near said head portion to aid in holding said handle shaft against the rim of the container.

5. A utensil according to claim 4, wherein said handle shaft defines an area in plan view and wherein said one or more perforations are provided over at least a portion of said area of said handle shaft in plan view.

6. A utensil according to claim 5, wherein said handle shaft is in the form of an elongated flat plate.

7. A utensil according to claim 6, wherein said handle shaft is in the form of a rectangular, elongated flat plate.

8. A utensil according to claim 4, wherein said head portion is a ladle head portion.

9. A utensil according to claim 8, wherein said head portion has one or more perforations to provide a straining capability.

10. A utensil according to claim 4, wherein said head portion is a spoon head portion.

11. A utensil according to claim 10, wherein said head portion has one or more perforations to provide a straining capability.

12. A utensil according to claim 3, wherein said handle shaft defines an area in plan view and wherein said one or more perforations are provided over at least a portion of said area of said handle shaft in plan view.

13. A utensil according to claim 12, wherein said handle shaft is in the form of an elongated flat plate.

14. A utensil according to claim 12, wherein said handle shaft is in the form of a rectangular, elongated flat plate.

15. A utensil according to claim 3, wherein said head portion is selected from a ladle head portion and a spoon head portion.

16. A utensil according to claim 15, wherein said head portion has one or more perforations to provide a straining capability.

17. A utensil according to claim 3, wherein said head portion has one or more perforations to provide a straining capability.

18. A utensil according to claim 3, wherein said one or more perforations provided in said handle shaft are a plurality of perforations.

19. A utensil according to claim 3, wherein said handle portion has a distal end that is farthest from the handle shaft and wherein said distal end of said handle portion is provided with a hole for hanging the utensil on a hook or peg for storage.
